(19) United States
(12) Patent Application Publication
(10) Pub. No.: US 2026/0099302 A1
(43) Pub. Date: Apr. 9, 2026

(54) LLM TEXT EDITING USING UUID LINE TAGS

(71) Applicant: Sony Interactive Entertainment LLC, San Mateo, CA (US)

(72) Inventors: Khalil Bibi, San Mateo, CA (US); Joseph Logan Olson, San Mateo, CA (US); Evan Jones, San Mateo, CA (US); Kyungseo Cho, San Mateo, CA (US)

(21) Appl. No.: 18/911,181

(22) Filed: Oct. 9, 2024

(51) Int. Cl. G06F 8/35

(52) U.S. Cl. CPC G06F 8/35

(57) ABSTRACT

In one aspect, a generative text model can be used to generate coding editing instructions according to a natural language prompt. Specifically, unique ID line tags may be prepended to lines of the code that are to be edited. The code with unique ID line tags may then be given to a generative model along with a natural language prompt setting forth one or more parameters for the edits. The LLM may then be used to generate the customized editing instructions. The editing instructions may then be received from the LLM and used post-processing to edit the code. After that, the unique ID line tags may be removed and the edited code may be returned to the user.

### FIELD

The disclosure below relates to technically inventive, non-routine solutions that are necessarily rooted in computer technology and that produce concrete technical improvements. In particular, the disclosure below relates to large language model (LLM)-based text editing using universally unique identifier (UUID) line tags.

### BACKGROUND

As recognized herein, large language models (LLMs) are auto-regressive, which for present principles means that the LLMs cannot natively edit a text string of computer code. So if a programmer wrote “console.log(“snakes are mean”)” and wanted to change “snakes” to “dogs”, the LLM would write the whole line anew and again. If the line of code is within a larger document, the LLM would rewrite the entire document again. This is computationally intensive and results in undue latency in producing the edited code.

### SUMMARY

Present principles advantageously enable use of LLMs to, rather than rewriting an entire body of code, edit the code in a computationally less-rigorous manner with less latency, less redundant text, and less errors (e.g., for when the same string occurs more than once in the code). To do so, each line of code may be tagged with a UUID (or other unique ID) and then the LLM may be prompted to create an editing instruction list. The editing instructions list may then be used to perform the edits post-processing.

Accordingly, in one aspect an apparatus includes at least one processor system configured to receive a prompt to a large language model (LLM). The prompt includes a request, in natural language, for editing instructions for editing one or more lines of code according to one or more parameters indicated in the prompt. The at least one processor system is also configured to, based on the prompt, provide the prompt and the one or more lines of code to the LLM and use the LLM to generate the editing instructions for editing the one or more lines of code. Each of the one or more lines of code indicates a respective universally unique identifier (UUID) located at the beginning of the respective line of code. The at least one processor system is further configured to receive the editing instructions from the LLM and to edit the one or more lines of code according to the editing instructions.

In various example implementations, the editing instructions may be output by the LLM as a list of editing instructions for editing different lines of the one or more lines of code. Here, each of the editing instructions in the list may indicate a respective UUID for each line of code to be edited.

Also in some example implementations, the at least one processor system may be configured to prepend the UUIDs to the respective lines of code prior to providing the one or more lines of code to the LLM. Responsive to receiving the editing instructions from the LLM, the at least one processor system may then be configured to edit the code according to the editing instructions, remove the UUIDs from the respective lines of code, and return the edited code to a user (sans UUIDs). The UUIDs prepended to each respective line of code may be random UUIDs that themselves may include alphabetical characters if desired.

In various example embodiments, the editing instructions may indicate an insert action to insert a chunk of code after a specific line indicated, via UUID, in the editing instructions. Also in various example embodiments, the editing instructions may indicate a delete action to drop a code snippet from a specific line identified, via UUID, in the editing instructions.

Additionally or alternatively, the editing instructions may indicate a replace action to replace a first code snippet in a specific line of code with a second code snippet different from the first code snippet, with the specific line of code being identified in the editing instructions via UUID. In one specific instance, the editing instructions may indicate a replace operation to replace plural first code snippets in plural lines of code with second plural code snippets different from the first code snippets, with the plural lines of code being identified in the editing instructions via a range of UUIDs.

In another aspect, a method includes receiving a prompt to a model. The prompt includes a request, in natural language, for editing instructions for editing one or more lines of code according to one or more parameters indicated in the prompt. The method also includes, based on the prompt, providing the prompt and the one or more lines of code to the model and using the model to generate the editing instructions for editing the one or more lines of code. Each of the one or more lines of code indicates a respective unique identifier (ID) located at the beginning of the respective line of code. The method also includes receiving the editing instructions from the model and editing the one or more lines of code according to the editing instructions.

In various examples, the model may be a generative text model, such as a large language model (LLM).

In still another aspect, an apparatus includes at least one computer readable storage medium (CRSM) that is not a transitory signal. The at least one CRSM includes instructions executable by a processor system to receive input to a model, with the input including a request in natural language for editing instructions for editing one or more lines of code according to one or more parameters indicated in the input. The instructions are also executable to, based on the input, provide the input and the one or more lines of code to the model and use the model to generate the editing instructions for editing the one or more lines of code. Each of the one or more lines of code indicates a respective unique identifier (ID). The instructions are further executable to receive the editing instructions from the model and to edit the one or more lines of code according to the editing instructions.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a schematic diagram according to present principles for using an LLM or other model to generate code editing instructions which can then be applied to edit the code itself;

FIG. 3 shows example logic in example flow chart format that may be executed by an apparatus consistent with present principles;

FIG. 4 shows an example graphical user interface (GUI) that may be used by an end-user to provide natural language input of code edits that the user wants to make consistent with present principles; and

FIG. 5 shows an example GUI that may be presented to return code, sans UUID, with edits to the code per an editing instruction list consistent with present principles.

### DETAILED DESCRIPTION

The detailed description below provides technical systems and methods for editing code (and other text data) with more accuracy and less tokens than other techniques. To do so, a unique 3-character ID may be prepended to each line of code, with it being further noted that IDs of other character lengths may also be used. The LLM may then be prompted to generate editing instructions. The editing instructions may include insert, delete, and replace actions. The editing instructions may then be used for editing of the code in a post-processing step.

Thus, in one example implementation, an LLM may be prompted to make some edits to a code project, starting by generating a whole project representation. All files in the project may be parsed and one single string may then be concatenated that represents the whole project according to the following format:
**filepath**
″′
file content
″′

Thereafter, a three-character ID can be prepended to each line of the file/project content. Those IDs will be used later on to identify the lines where the device is to make the edits.

After that, the LLM is prompted to generate an editing instructions list, such as according to the following examples.

If the edit is inserting a chunk of code, the device may first generate a line starting with “INSERT” followed by a comma followed by the line ID after which it wants to make the edits followed by the file path where it wants to apply the edit. For example, if the device wants to insert a code after line starting with “KwL” in “src/index.ts” it will generate “INSERT,KwL,src/index.ts” and, if the device wants to insert code at the first line it will generate “INSERT,0,filepath”. After generating this line the device will include the code snippet to insert between ″′ and ″′ in new lines.

If the edit is removing a chunk of code (could be one or multiple lines), the device can generate a single line starting with “REMOVE” followed by the lines IDs of the line to start deleting and the line to stop deleting at inclusive separated by commas, followed by the file path where it wants to do the REMOVE. If the device wants to remove one single line, the starting line and ending line indexes can be the same.

If the edit is replacing a chunk of code (could be one or multiple lines), the device can first generate a line to localize the chunk to be replaced. The line can start with “REPLACE” followed by a comma followed by the line ID from which to start replacing followed by a comma followed by the line ID of the line where the device is to stop replacing, followed by a comma followed by the file path where to apply the REPLACE edit. For example, if the device wants to replace all code between lines “PoK” and “AKt” in “src/game.ts”, it can generate “REPLACE,PoK,AKt,src/game.ts”. After generating this line, the device may generate the code snippet to replace with between ″′ and ″′ in new lines.

Once the editing instructions list is generated, the device can receive the list from the LLM and apply the list to edit the code. After that, the device can drop the UUIDs from the beginning of each line and return the edited code to the user.

With the foregoing in mind, it is to be understood that this disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors acting independently or in concert with each other to execute an algorithm, whether those processors are in one device or more than one device.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

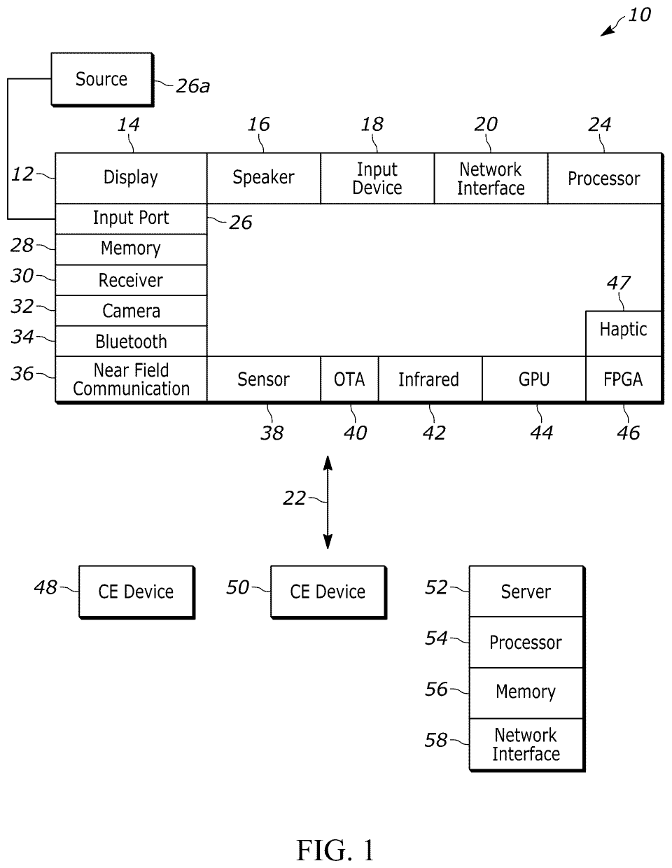

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12 consistent with present principles. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer/video game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player, or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components discussed in herein. Any user interfaces (UI) described herein may be consolidated and/or expanded, and UI elements may be mixed and matched between UIs.

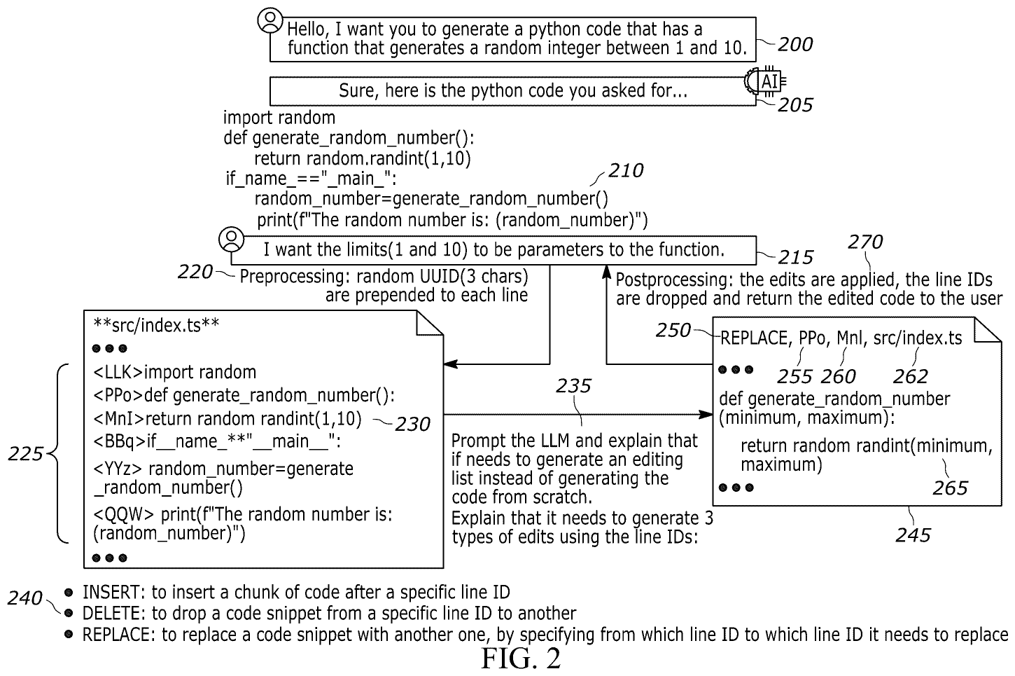

Now in reference to the schematic diagram of FIG. 2, suppose a software developer wants to edit code that is being developed. Consistent with present principles, the developer can use natural language input to an LLM to do so, with the overall prompt being engineered to trigger the LLM to generate coding editing instructions according to the editing parameters of the natural language input. This may advantageously enable more-accurate computer-based code editing and reduced token use (which in turn saves time). Thus, improved speed and accuracy are realized in using generative text models for code-based tasks.

Thus, in one embodiment, UUID line tags may be prepended to lines of code that are to be edited. The code with UUID line tags may then be given to the generative model along with the natural language prompt, and the LLM may then be used to generate customized editing instructions. In some examples, a system prompt (e.g., in addition to other system prompts that might be used by the LLM) may also be used in combination with the user prompt, with the system prompt indicating “You are a world class game designer and typescript programmer” in one specific instance. The editing instructions that are then output by the LLM in response can be used post-processing to edit the code. The UUIDs line tags can then be removed. This process avoids having the LLM generate the whole code again from scratch just to make the edit(s).

With the following in mind, FIG. 2 shows that in one example, a user might provide the following natural language input 200: “Hello, I want you to generate a python code that has a function that generates a random integer between 1 and 10.” In response, the model may return the following natural language response 205 and code 210: “Sure, here is the python code you asked for . . . [Python code]”. Then suppose the user wants to edit the code that was produced by the model, providing another natural language input 215 that, “I want the limits (1 and 10) to be parameters to the function.”

Implementing present principles, the device may then execute preprocessing 220 (e.g., using Python or TypeScript) to prepend different random three-character UUIDs 225 to each respective line of code 230. Then at 235 the device may prompt the LLM, with the prompt explaining that the LLM should generate an editing instruction list instead of generating the entire code again from scratch as it otherwise would to perform the edit. The prompt can also explain that the LLM should generate one to three types 240 of edits using UUIDs (or other types of unique line IDs). A first type may be an insert edit to insert a chunk of code after a specific line ID. A second type may be a delete edit to drop a code snippet from a specific line ID to another specific line ID. A third type may be a replace edit to replace a code snippet with another one by specifying from which line ID to which line ID the device needs to replace.

In response to prompting the LLM, the device may receive editing instructions 245 back from the LLM. Note that the editing instructions 245 indicate an edit action 250, a first line ID 255 from which to start a replace action, a second line ID 260 at which to stop the replace action, the respective line of code to be edited, and the file path 262 of the file itself that has the code being edited. In specific non-limiting examples, the file path 262 may be included in multi-file editing scenarios and may be omitted in single-file editing scenarios. Other data may be included in the editing instructions 245 as well, such as the replacement code/snippet 265 that is to replace the existing code in the lines “PPo”to “Mnl”.

The device can then receive the editing instructions from the LLM to, at 270 in post-processing (e.g., using Python or TypeScript), apply the edits and drop (delete) the line IDs from the respective lines of code. The edited code can then be returned to the user (sans line IDs) at the user's client device.

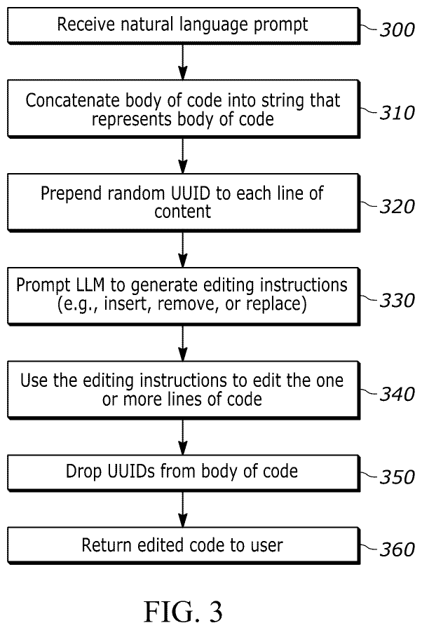

FIG. 3 shows example logic that further illustrates. The logic of FIG. 3 may be executed by an apparatus such as a client device and/or coordinating server alone or in any appropriate combination consistent with present principles. Thus, in some examples the logic may be executed by a client device alone. In other examples, the logic may be executed by the remotely-located server alone. In still other examples, the logic may be executed by a client device and remotely-located server, where the client device performs some steps while the server performs other steps, and/or where the client device and server work together to perform a given step. Note that while the logic of FIG. 3 is shown in flow chart format, other suitable logic may also be used.

Beginning at block 300, the apparatus may receive a natural language prompt/input from a human user, such as a software developer. The natural language input may include a request for editing instructions, with the request also indicating parameters for one or more edits that the user wants to make to a body of code. In some examples, the user may cut and paste the code itself into the prompt, providing the code as part of the user's input. The logic may then proceed to block 310 where the apparatus may concatenate the body of code into a string that represents the body of code.

Then logic may then proceed to block 320 where, in pre-processing, the apparatus may prepend a different, random UUID (or other type of line ID) to each line of the body of code. The UUIDs may be enclosed in brackets (e.g., “<PPo>”), and each UUID may appear in only one line of code and no other lines of the code. In one specific example, at least one character of each UUID may include an alphabetic character, and certain alphabetic characters may be capitalized while others may not. Additionally, the UUIDs for consecutive lines of code may not include consecutive UUIDs for those lines (e.g., according to any numerical or alphabetical order, or combined alpha-numeric order). Present principles recognize that these techniques may be used to control the LLM to give an accurate response based on the understanding that many LLMs are inept at providing accurate responses using consecutive line numbers.

From block 320 the logic may then proceed to block 330. At block 330 the apparatus may provide the prompt and code that is to be edited to the LLM for the LLM to generate editing instructions, such as instructions to insert code, remove/delete code, or replace code from the body of code that is indicated by the user. The prompt may therefore include the user's natural language input requesting one or more particular edits or other changes to the body of code itself, along with the concatenated string that represents the body of code (and the code itself with prepended UUIDs for each line). Other parameters may also be included in the prompt.

From block 330 the logic may then proceed to block 340. At block 340 the apparatus may receive the editing instructions back from the LLM (e.g., after also executing the LLM to generate the instructions). The editing instructions may be output by the LLM as a list of editing instructions for editing different lines of the one or more lines of code, with each of the editing instructions in the list indicating a respective UUID for each line of code to be edited (and/or indicating a range of UUIDs for a range of lines that are to be edited).

Thus, in various examples, the editing instructions may indicate an insert action to insert a chunk of code after a specific line indicated, via UUID, in the editing instructions. The editing instructions may additionally or alternatively indicate a remove/delete action to drop a code snippet from a specific line identified, via UUID, in the editing instructions. As another example, the editing instructions may indicate a replace action to replace a first code snippet in a specific line of code with a second code snippet different from the first code snippet, with the specific line of code identified in the editing instructions via UUID. As yet another example, the editing instructions may indicate a replace operation to replace plural first code snippets in plural lines of code with second plural code snippets different from the first code snippets, with the plural lines of code identified in the editing instructions via a range of UUIDs.

Also at block 340, in post-processing, the apparatus may use the editing instructions to edit the one or more lines of code according to the editing instructions (which themselves have been generated based on the user's parameter(s) for the specific edit(s) the user is seeking). In one particular example, a whole function may be used to perform the edits using the editing instructions, though other coding functions may also be used. Also as post-processing, the apparatus at step 350 may remove the UUIDs from each line of the edited body of code and then, at step 360, return the edited code to the user. For example, the edited code may be presented on the display of the user's client device for the user to inspect the code and potentially cut and paste the code elsewhere.

With FIGS. 2 and 3 in mind, note that different types of prompts may be provided to the model to get a desired editing instruction list from the model consistent with present principles. A first example type may be a prompt “with explanation” in which the LLM is prompted to generate an overall explanation of the edits that are to be done, with the LLM-generated explanation then being provided back to the LLM as input in a second round of LLM execution to prompt the LLM to generate the editing instructions using the explanation.

A second example type of prompt may be a prompt “with step explanation” in which the LLM is prompted to generate the editing instructions, but before generating any editing instruction(s), the LLM generates an individual explanation about each respective edit first. In this way, the LLM provides itself with a step-by-step explanation in natural language since the LLM is already configured to process in natural language. Thus, the LLM may generate the step-by-step explanation(s) to then generate the editing instruction(s) themselves using the step-by-step explanation(s).

A third example type of prompt may be a prompt without explanation in which the LLM is prompted to generate an editing instruction list without any explanation of the edits being generated by the LLM beforehand (step-by-step explanation or otherwise).

Any of the three type above may be used consistent with present principles, with present principles further recognizing that in various non-limiting examples, the second type (prompt with step explanation) may be the most-optimized for many foundational LLMs in order to get back editing instructions that are accurate and complete while minimizing drift and loss of context.

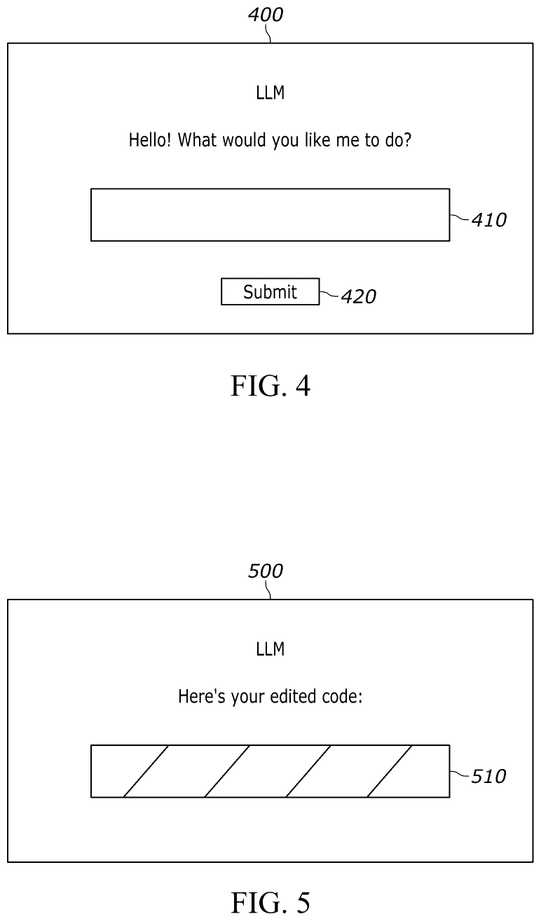

FIG. 4 further illustrates present principles. Here, a graphical user interface (GUI) 400 is presented on a display. The GUI 400 provides an interface for a user to provide a prompt/input to an LLM (or other generative text model) using the prompt input box 410. The user input may include a “with explanation” prompt, a “with step explanation” prompt, or a “without explanation” prompt as described above. The submit selector 420 may then be selected to initiate a code editing operation where the LLM is used to generate an editing instructions list for post-processing editing of the relevant code. Thus, in one example, selection of the submit selector 420 after entering the prompt into the box 410 may command the apparatus to execute the logic of FIG. 3 to edit code according to a specific code editing request specified by the user in the box 410.

FIG. 5 then shows another example GUI 500 that may be presented on the user's client device display once the LLM has been used to generate the editing instructions and post-processing has been done to edit the code according to the editing instructions themselves. The apparatus may therefore return the code to the user by presenting the edited code 510 on the GUI 500.

However, further note in relation to FIGS. 4 and 5 that in some example non-limiting instances, the GUIs 400 and 500 may not be presented as the LLM-based code editing software described above may be integrated an editor application.

It may now be appreciated that present principles enable auto-regressive models that write in one direction to be used for editing code, using natural language requests and unique IDs for each line of code to edit large files quickly with less processing resources and less device errors.

While the particular embodiments are herein shown and described in detail, it is to be understood that the subject matter which is encompassed by the present application is limited only by the claims.

What is claimed is:

1. An apparatus, comprising:
at least one processor system configured to:
receive a prompt to a large language model (LLM), the prompt comprising a request, in natural language, for editing instructions for editing one or more lines of code according to one or more parameters indicated in the prompt;
based on the prompt, provide the prompt and the one or more lines of code to the LLM and use the LLM to generate the editing instructions for editing the one or more lines of code, each of the one or more lines of code indicating a respective universally unique identifier (UUID) located at the beginning of the respective line of code;
receive the editing instructions from the LLM; and
edit the one or more lines of code according to the editing instructions.

2. The apparatus of claim 1, wherein the editing instructions are output by the LLM as a list of editing instructions for editing different lines of the one or more lines of code, each of the editing instructions in the list indicating a respective UUID for each line of code to be edited.

3. The apparatus of claim 1, wherein the instructions are executable to:
prepend the UUIDs to the respective lines of code prior to providing the one or more lines of code to the LLM.

4. The apparatus of claim 3, wherein the at least one processor system is configured to:
responsive to receiving the editing instructions from the LLM, edit the code according to the editing instructions, remove the UUIDs from the respective lines of code, and return the edited code to a user.

5. The apparatus of claim 3, wherein the UUIDs prepended to each respective line of code are random UUIDs.

6. The apparatus of claim 5, wherein the random UUIDs comprise alphabetical characters.

7. The apparatus of claim 1, wherein the editing instructions indicate an insert action to insert a chunk of code after a specific line indicated, via UUID, in the editing instructions.

8. The apparatus of claim 1, wherein the editing instructions indicate a delete action to drop a code snippet from a specific line identified, via UUID, in the editing instructions.

9. The apparatus of claim 1, wherein the editing instructions indicate a replace action to replace a first code snippet in a specific line of code with a second code snippet different from the first code snippet, the specific line of code identified, via UUID, in the editing instructions.

10. The apparatus of claim 1, wherein the editing instructions indicate a replace operation to replace plural first code snippets in plural lines of code with second plural code snippets different from the first code snippets, the plural lines of code identified, via a range of UUIDs, in the editing instructions.

11. A method, comprising:
receiving a prompt to a model, the prompt comprising a request, in natural language, for editing instructions for editing one or more lines of code according to one or more parameters indicated in the prompt;
based on the prompt, providing the prompt and the one or more lines of code to the model and using the model to generate the editing instructions for editing the one or more lines of code, each of the one or more lines of code indicating a respective unique identifier (ID) located at the beginning of the respective line of code;
receiving the editing instructions from the model; and
editing the one or more lines of code according to the editing instructions.

12. The method of claim 11, wherein the model is a generative text model.

13. The method of claim 12, wherein the model is a large language model (LLM).

14. The method of claim 11, the editing instructions are output by the model as a list of editing instructions for editing different lines of the one or more lines of code, each of the editing instructions in the list indicating a respective unique ID for each line of code to be edited.

14. The method of claim 11, comprising:
prepending the unique IDs to the respective lines of code prior to providing the one or more lines of code to the model.

15. The method of claim 11, comprising:
responsive to receiving the editing instructions from the model, editing the code according to the editing instructions, removing the unique IDs from the respective lines of code, and returning the edited code to a user.

16. The method of claim 11, wherein the editing instructions indicate an insert action to insert a chunk of code after a specific line indicated, via unique ID, in the editing instructions.

17. The method of claim 11, wherein the editing instructions indicate a delete action to drop a code snippet from a specific line identified, via unique ID, in the editing instructions.

18. The method of claim 11, wherein the editing instructions indicate a replace action to replace a first code snippet in a specific line of code with a second code snippet different from the first code snippet, the specific line of code identified, via unique ID, in the editing instructions.

19. An apparatus, comprising:
at least one computer readable storage medium (CRSM) that is not a transitory signal, the at least one CRSM comprising instructions executable by a processor system to:
receive input to a model, the input comprising a request, in natural language, for editing instructions for editing one or more lines of code according to one or more parameters indicated in the input;
based on the input, provide the input and the one or more lines of code to the model and use the model to generate the editing instructions for editing the one or more lines of code, each of the one or more lines of code indicating a respective unique identifier (ID);
receive the editing instructions from the model; and
edit the one or more lines of code according to the editing instructions.

20. The apparatus of claim 19, wherein the instructions are executable to:
prepend the unique IDs to the respective lines of code prior to providing the one or more lines of code to the model; and
responsive to receiving the editing instructions from the model, edit the code according to the editing instructions, remove the unique IDs from the respective lines of code, and return the edited code at a client device.
